(19) United States
(12) Patent Application Publication
(10) Pub. No.: US 2017/0286259 A1
(43) Pub. Date: Oct. 5, 2017

(54) INFORMATION PROCESSING APPARATUS, INFORMATION PROCESSING SYSTEM, AND COMPUTER-READABLE RECORDING MEDIUM

(71) Applicant: FUJITSU LIMITED, Kawasaki-shi (JP)

(72) Inventors: Takuji Watanabe, Chofu (JP); Akimasa Yoshida, Nagoya (JP)

(73) Assignee: FUJITSU LIMITED, Kawasaki-shi (JP)

(21) Appl. No.: 15/457,225

(22) Filed: Mar. 13, 2017

(30) Foreign Application Priority Data
Apr. 4, 2016 (JP) 2016-075134

(51) Int. Cl. G06F 11/36

(52) U.S. Cl. CPC G06F 11/3612

(57) ABSTRACT

A command transmission unit transmits a command input from a terminal device to an operational environment VM and a verification VM, which is generated such that configuration change is added to a configuration of the operational environment VM, and causes the operational environment VM and the verification VM to execute the command. A result acquisition unit acquires an operation-side output by the operational environment VM and a verification-side output by the verification VM for the command transmitted by the command transmission unit. A result transmission unit transmits the operation-side output acquired by the result acquisition unit to the terminal device. A determination unit determines success or failure of the configuration change on the basis of the operation-side output and the verification-side output acquired by the result acquisition unit.

### CROSS-REFERENCE TO RELATED APPLICATION

This application is based upon and claims the benefit of priority of the prior Japanese Patent Application No. 2016-075134, filed on Apr. 4, 2016, the entire contents of which are incorporated herein by reference.

### FIELD

The embodiments discussed herein are related to an information processing apparatus, an information processing system, and a configuration change verification program.

### BACKGROUND

In recent years, various information processing systems that provide various services adapted to the needs of users have been provided with the spread of various information processing apparatuses. For example, in a case of providing the various services to the users through the Internet or the like, use of data centers, in which a large number of servers and storages for providing the services are put together, and which operate and manage the servers and storages, has been increased.

In such an information processing system, configuration change of the system is frequently performed from a perspective of operation management such as fixation of bugs, enhancement of security, or improvement of processing performance. Examples of the configuration change of the system include update of software such as upgrade of an operating system (OS) or an application, and configuration change of hardware such as a network configuration.

Conventionally, in a case of performing the configuration change of the system, a system administrator who performs verification typically creates a verification environment, and performs the configuration change and verification, using the created verification environment. In this case, the system administrator executes a test set prepared in advance in the verification environment to which the configuration change is added, and confirms appropriateness of the configuration change. After that, the system administrator conducts the configuration change and the verification, which have been performed in the verification environment, for the information processing system in an operational environment actually used and operated for business, and applies the configuration change to the information processing system in the operational environment. Here, the test set is a program for performing a series of processing using commands and data supposed to be used in the operational environment.

As a technology regarding operation management of an information processing system, there is a conventional technology to store a command executed in a verification environment and an execution result, execute the same command in an operational environment, and compare the results to verify whether an accurate operation is performed.

Further, there is a conventional technology to analyze a system log of an operational environment, acquire an operation procedure, generate an operation scenario, execute the generated operation scenario in a verification environment to confirm a result. Further, there is a conventional technology to execute a performance test in some verification environments to acquire snapshots and throughputs, and adapt a configuration of the verification environment having the configuration suitable for a load expected in an information processing system in an operational environment, to the information processing system in an operational environment.

Patent Literature 1: Japanese Laid-open Patent Publication No. 2012-185599

Patent Literature 2: Japanese Laid-open Patent Publication No. 2007-140954

Patent Literature 3: Japanese Laid-open Patent Publication No. 2011-113267

However, in the case of executing the test set in the verification environment and performing the verification like the conventional technology, the system administrator favorably prepares a test set suited for the system in advance to verify the environment to which the configuration change has been added. For example, considering the data center, a plurality of systems exists in one data center, and an item to be confirmed differs in each of the systems. For example, the test set differs in each of functions of the system, such as a web server or an application server, and further, the test set favorably differs in each OS operated in the system, such as a UNIX (registered trademark) OS or a Windows (registered trademark) OS. Therefore, in the conventional method, every time a system is increased in the data center, the system administrator needs to prepare a test set suited for the system, and a processing load of the system administrator associated with the configuration change becomes high.

Even if the conventional technology to compare the execution results of the command between the verification environment and the operational environment is used, the test set needs to be prepared for each different system, and reduction of the processing load of the system administrator is difficult. Further, even in the conventional technology to execute, in the verification environment, the operation scenario generated in the operation procedure and in the conventional technology to adapt the suitable configuration from the performance test result in the verification environment, the test set is prepared for each system, and thus reduction of the processing load of the system administrator is difficult.

### SUMMARY

According to an aspect of an embodiment, an information processing apparatus includes: An information processing apparatus comprising: a processor configured to: transmit a command input from a terminal device to a first arithmetic processing device and a second arithmetic processing device generated such that configuration change is added to a configuration of the first arithmetic processing device, and cause the first arithmetic processing device and the second arithmetic processing device to execute the command; acquire a first execution result by the first arithmetic processing device and a second execution result by the second arithmetic processing device for the transmitted command; transmit the acquired first execution result to the terminal device; and determine success or failure of the configuration change on the basis of the first execution result and the second execution result acquired.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWING(S)

FIG. 1 is a configuration diagram of an information processing system;

FIG. 2 is a block diagram of the information processing system including a relay device according to a first embodiment;

FIG. 3 is a diagram illustrating an example of a connection destination table;

FIG. 4 is a diagram illustrating an example of an input exclusion list;

FIG. 5 is a diagram illustrating an example of verification data;

FIG. 6 is a diagram illustrating an example of verification data corresponding to an operation transmitted from a terminal device;

FIG. 7 is a diagram of an example of data used for determination of an operation transmitted from a new function verification terminal device;

FIG. 8 is a block diagram of an information processing system including a relay device according to a second embodiment;

FIG. 9 is a diagram illustrating an example of a conversion table;

FIG. 10 is a diagram for describing an example of processing of when comparison is performed using the conversion table;

FIG. 11 is a diagram for describing an example of processing of when comparison is performed using the input exclusion list and the conversion table;

FIG. 12 is a sequence diagram of verification environment generation processing;

FIG. 13 is a sequence diagram of execution result comparison processing;

FIG. 14 is a sequence diagram of completion processing; and

FIG. 15 is a hardware configuration diagram of the relay device.

### DESCRIPTION OF EMBODIMENTS

Preferred embodiments of the present invention will be explained with reference to accompanying drawings.

Note that the information processing apparatus, the information processing system, and the configuration change verification program disclosed by the present application are not limited by the embodiments below.

### [a] First Embodiment

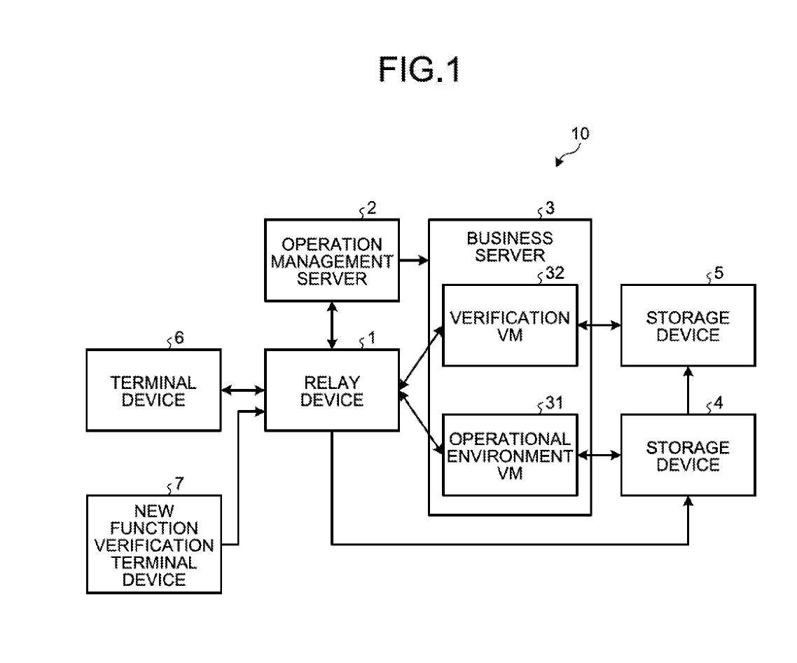

FIG. 1 is a configuration diagram of an information processing system. An information processing system 10 includes a relay device 1, an operation management server 2, a business server 3, a storage device 4, a storage device 5, a terminal device 6, and a new function verification terminal device 7.

The business server 3 executes an operational environment virtual machine (VM) 31. Further, FIG. 1 illustrates a state in which the business server 3 executes a verification VM 32. As described below, the verification VM 32 is a virtual server formed when verification for configuration change is executed. Therefore, the verification VM 32 is allowed to not exist in the business server 3 before the start of verification processing.

The operational environment VM 31 and the verification VM 32 may be arranged in different servers. The operational environment VM 31 is a virtual server used for business processing at a point of time before the verification, and in which an actual operation is performed. The operational environment VM 31 is connected with the storage device 4.

The operational environment VM 31 receives a command that instructs an operation transmitted from the terminal device 6 through the relay device 1. Hereinafter, the command that instructs an operation may be simply called “operation”. The operation corresponds to an example of the “command”.

The operational environment VM 31 executes the received operation, using the storage device 5, and transmits an execution result of the operation to the terminal device 6 through the relay device 1. This operational environment VM 31 corresponds to an example of a “first arithmetic processing device”.

The operation management server 2 is a server for performing operation management of the information processing system 10. The operation management server 2 receives an instruction of execution of verification of configuration change from a system administrator of the information processing system 10. Then, the operation management server 2 generates, in the business server 3, the verification VM 32 having a similar configuration to the operational environment VM 31 to be connected with the storage device 5. Further, the operation management server 2 adds configuration change as an object to be verified to the verification VM 32 to generate a verification environment. After that, when the verification is terminated, the operation management server 2 notifies the relay device 1 of verification termination upon receiving an instruction from the system administrator. This operation management server 2 corresponds to an example of an “operation management device”.

The relay device 1 relays the operation output from the terminal device 6 to the operational environment VM 31 at times other than execution of verification of configuration change of the operational environment VM 31. Further, when executing the verification of configuration change of the operational environment VM 31, the relay device 1 transmits the operation output from the terminal device 6 to the verification VM 32 generated by the operation management server 2 together with the operational environment VM 31. After that, the relay device 1 receives execution results of the operation from both the operational environment VM 31 and the verification VM 32. Then, the relay device 1 transmits the execution result received from the operational environment VM 31 to the terminal device 6, and compares the two execution results and determines success or failure of the configuration change.

Further, when receiving an operation from the new function verification terminal device 7, the relay device 1 transmits the received operation to the verification VM 32. After that, the relay device 1 acquires an execution result from the verification VM 32. Then, the relay device 1 determines success or failure of the configuration change, using the execution result. The relay device 1 will be described in detail below. This relay device 1 corresponds to an example of an “information processing apparatus”.

The terminal device 6 is a client terminal used by a user of the information processing system 10. The user inputs, using the terminal device 6, an operation for causing the operational environment VM 31 to execute the business processing and the like. The terminal device 6 transmits the input operation to the operational environment VM 31 through the relay device 1. After that, the terminal device 6 acquires the execution result of the operation by the operational environment VM 31 and the storage device 4 from the relay device 1, and provides the execution result to the user.

When performing configuration change to add a new function not mounted on the operational environment VM 31, the new function verification terminal device 7 transmits an operation for confirming an operation of the new function to the verification VM 32 through the relay device 1.

The storage device 4 is a storage device connected to the operational environment VM 31, and used when the operational environment VM 31 executes an operation to perform processing. The storage device 5 is a storage device connected to the verification VM 32, and used when the verification VM 32 executes an operation to perform processing. In the present embodiment, the storage device 4 and the storage device 5 are different devices. However, an embodiment is not limited thereto, and the storage devices 4 and 5 may be one storage device as long as areas used by the operational environment VM 31 and the verification VM 32 are different.

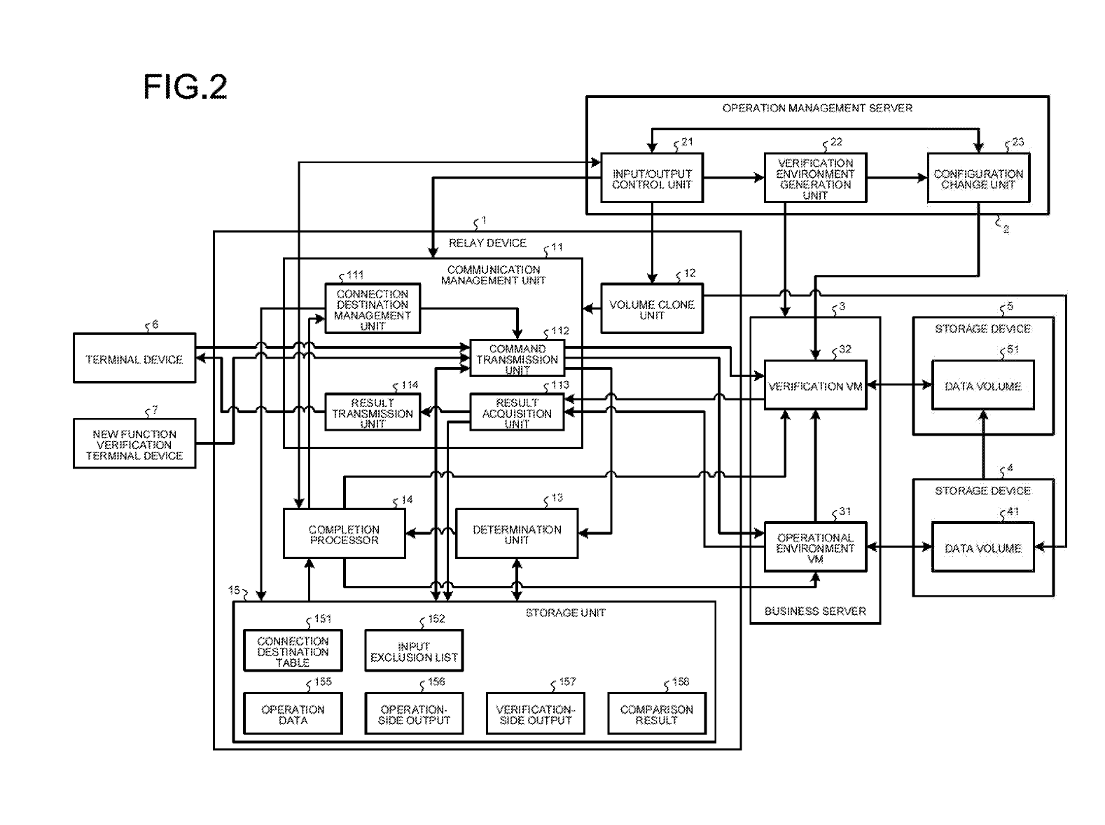

Next, the relay device 1 and the operation management server 2 will be described in detail with reference to FIG. 2. FIG. 2 is a block diagram of the information processing system including the relay device according to the first embodiment.

The operation management server 2 will be described. As illustrated in FIG. 2, the operation management server 2 includes an input/output control unit 21, a verification environment generation unit 22, and a configuration change unit 23.

The input/output control unit 21 includes an output device such as a monitor, and input devices such as a keyboard and a mouse. The input/output control unit 21 receives an input from the system administrator, using the input device.

For example, the input/output control unit 21 receives an input of an instruction of a configuration of a verification environment for verification, of configuration change to be added to the operational environment VM 31. In this case, the input/output control unit 21 receives an input of content of the configuration change to be added to the operational environment VM 31.

Then, the input/output control unit 21 outputs an instruction of generation of the verification environment having a configuration similar to the operational environment VM 31 to the verification environment generation unit 22. Further, the input/output control unit 21 outputs the content of the configuration change to be added to the operational environment VM 31 to the configuration change unit 23. After that, the input/output control unit 21 notifies the system administrator of completion of the configuration change upon receiving the notification of completion of the configuration change from the verification environment generation unit 22.

After that, the input/output control unit 21 receives an input of an instruction of verification start. At this time, the input/output control unit 21 also receives designation of a type of the configuration change such as whether the configuration change to be verified is configuration change not involving function addition, configuration change involving function addition, or configuration change involving operation change. The configuration change not involving function addition is configuration change in which no new function is added to the operational environment VM 31. Further, the configuration change involving function addition is configuration change in which a new function is added to the operational environment VM 31. Further, the configuration change involving operation change is configuration change including change of an operation form such as change of a set parameter of an application, and the like.

Next, the input/output control unit 21 transmits the instruction of verification start to the relay device 1. After that, the input/output control unit 21 receives an input of an instruction of verification termination from the system administrator. Then, the input/output control unit 21 transmits an instruction of verification completion to the relay device 1.

The verification environment generation unit 22 receives an input of the instruction of generation of the verification environment having a configuration similar to the operational environment VM 31 from the input/output control unit 21. Then, the verification environment generation unit 22 causes the business server 3 to clone a virtual image of the operational environment VM 31 to generate the verification VM 32 in the business server 3. Then, the verification environment generation unit 22 outputs notification of generation completion of the verification environment to the configuration change unit 23. This verification environment generation unit 22 corresponds to an example of a “generation unit”. Then, the verification VM 32 corresponds to an example of a “second arithmetic processing device”.

The configuration change unit 23 receives an input of the content of the configuration change to be added to the operational environment VM 31 from the input/output control unit 21. After that, the configuration change unit 23 receives an input of the notification of generation completion of the verification environment from the verification environment generation unit 22. Then, the configuration change unit 23 adds the configuration change of the content instructed to the verification VM 32 generated by the verification environment generation unit 22. After that, the configuration change unit 23 outputs notification of completion of the configuration change to the input/output control unit 21.

The relay device 1 will be described. As illustrated in FIG. 2, the relay device 1 includes a communication management unit 11, a volume clone unit 12, a determination unit 13, a completion processor 14, and a storage unit 15.

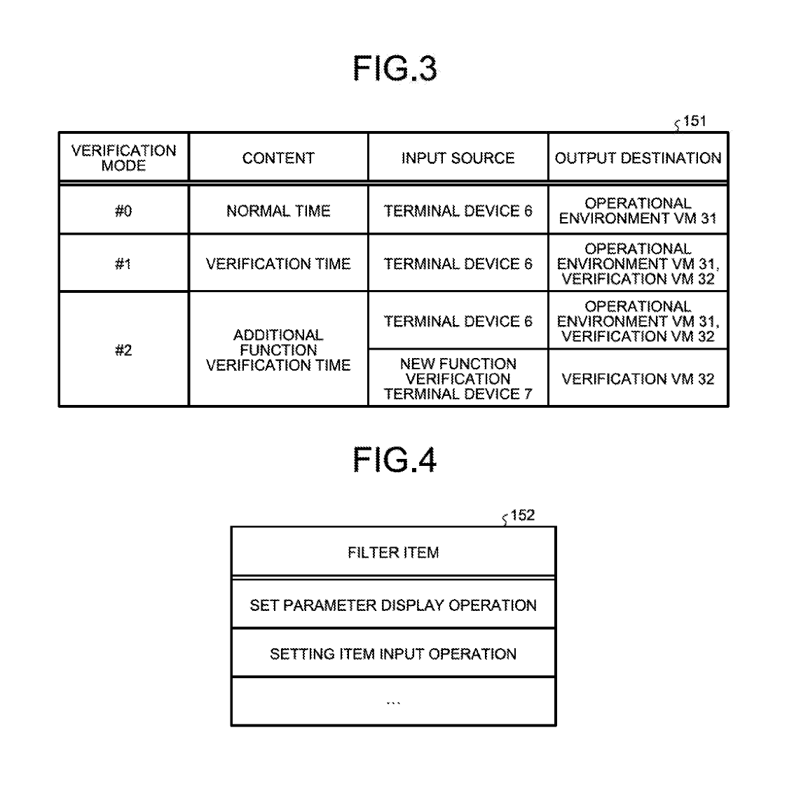

The storage unit 15 stores a connection destination table 151 and an input exclusion list 152 in advance. FIG. 3 is a diagram illustrating an example of the connection destination table. As illustrated in FIG. 3, in the connection destination table 151, connection destinations are registered for each verification mode. The connection destinations are an input source and an output destination of the operation received by the communication management unit 11 described below from the terminal device 6 or the new function verification terminal device 7.

There are three verification modes. A verification mode #0 is a mode at the normal time when normal processing without executing verification is performed. In the verification mode #0, the input source is the terminal device 6 and the output destination is the operational environment VM 31. Further, a verification mode #1 is a mode at the time of verification where verification not including an additional function is executed. In the verification mode #1, the input source is the terminal device 6 and the output destinations are the operational environment VM 31 and the verification VM 32. Further, a verification mode #2 is a mode at the time of additional function verification where verification including an additional function is executed. In the verification mode #2, when the input source is the terminal device 6, the output destinations are the operational environment VM 31 and the verification VM 32, and when the input source is the new function verification terminal device 7, the output destination is the verification VM 32.

Further, FIG. 4 is a diagram illustrating an example of the input exclusion list. The input exclusion list 152 is a list in which an operation to be excluded is recorded so as not to be compared with an execution result of an operation regarding an operation with operation change. As illustrated in FIG. 4, in the input exclusion list 152, information that identifies an operation to be excluded is recorded. This input exclusion list 152 corresponds to an example of an “information of an exclusion command”.

The connection destination table 151 and the input exclusion list 152 may be stored in the storage unit 15 in advance by the system administrator, using the operation management server 2, for example.

Further, as illustrated in FIG. 2, operation data 155, an operation-side output 156, a verification-side output 157, and a comparison result 158 are stored in the storage unit 15. Note that content of the operation data 155, the operation-side output 156, the verification-side output 157, and the comparison result 158 is registered and updated by the communication management unit 11 in the process of verification processing, as described below. Therefore, there is a case which the storage unit 15 does not hold the operation data 155, the operation-side output 156, the verification-side output 157, and the comparison result 158 at times other than execution of verification.

The volume clone unit 12 receives the instruction of verification start from the input/output control unit 21 of the operation management server 2. Then, the volume clone unit 12 causes the storage device 5 to clone a data volume 41 to be used by the operational environment VM 31 stored in the storage device 4, and generates a data volume 51 as a data volume to be used by the verification VM 32. After that, the volume clone unit 12 notifies the communication management unit 11 of completion of the volume creation.

The communication management unit 11 includes a connection destination management unit 111, a command transmission unit 112, a result acquisition unit 113, and a result transmission unit 114.

The connection destination management unit 11 determines a type of the configuration change included in the instruction of verification start when the instruction of verification start is given from the input/output control unit 21 of the operation management server 2 to the communication destination management unit 111. In the case of the configuration change not involving function addition or the configuration change involving an operation change, the connection destination management unit 111 determines the verification mode #1 in the connection destination table 151 as a current mode, and changes the connection destination. When the verification mode #1 is selected as the verification mode to be used, connection destination information to be used in the connection destination table 151 is changed from the connection destination in the verification mode #0 to the connection destination in the verification mode #1.

Further, in the case of the configuration change involving function addition, the connection destination management unit 111 determines the verification mode #2 in the connection destination table 151 as the current mode, and changes the connection destination. When the verification mode #2 is selected as the verification mode to be used, the connection destination information to be used in the connection destination table 151 is changed from the connection destination in the verification mode #0 to the connection destination in the verification mode #2. Here, in the present embodiment, the verification mode registered in advance in the connection destination table 151 is selected and the connection destination is changed. However, an embodiment is not limited thereto, and for example, the connection destination management unit 111 may register, to the connection destination table 151, the connection destination according to the type of the configuration change on a case-by-case basis.

After that, the connection destination management unit 111 receives an input of notification of verification completion from the completion processor 14. Then, the connection destination management unit 111 determines the verification mode #0 in the connection destination table 151 as the current mode, and changes the connection destination. When the verification mode #0 is selected as the verification mode to be used, the connection destination information to be used in the connection destination table 151 is changed from the connection destination in the verification mode #1 or #2 or the connection destination in the verification mode #0.

The command transmission unit 112 causes communication to be in a suspended state when the instruction of verification start from the input/output control unit 21 of the operation management server 2 to the communication management unit 11 is given. After that, the command transmission unit 112 cancels the suspended state of the communication when receiving inputs of notification of completion of connection destination change from the connection destination management unit 111 and notification of completion of the volume creation from the volume clone unit 12. Accordingly, the command transmission unit 112 can stop transmission of the operation to the operational environment VM 31 from when receiving the instruction of verification start to when preparation of execution of verification becomes ready.

Further, the command transmission unit 112 confirms the connection destination table 151, and identifies the selected verification mode. Then, in the verification mode #0, the command transmission unit 112 receives the input of an operation from the terminal device 6. Next, the command transmission unit 112 transmits the acquired operation to the operational environment VM 31.

Further, in the verification mode #1, the command transmission unit 112 receives the input of an operation from the terminal device 6. Then, the command transmission unit 112 transmits the acquired operation to the operational environment VM 31 and the verification VM 32. Further, the command transmission unit 112 registers the acquired operation as the operation data 155.

Further, in the verification mode #2, the command transmission unit 112 receives inputs of an operation from the terminal device 6 and the new function verification terminal device 7. Then, when receiving the input of an operation from the terminal device 6, the command transmission unit 112 transmits the acquired operation to the operational environment VM 31 and the verification VM 32. Further, the command transmission unit 112 registers the acquired operation as the operation data 155.

In contrast, when receiving the input of an operation from the new function verification terminal device 7, the command transmission unit 112 transmits the acquired operation to the verification VM 32. Further, the command transmission unit 112 registers the acquired operation as the operation data 155.

The result acquisition unit 113 acquires, from the operational environment VM 31, an execution result of the operation transmitted from the command transmission unit 112. Then, the result acquisition unit 113 registers the acquired execution result correspondingly to the operation data 155 as the operation-side output 156. Further, the result acquisition unit 113 outputs the acquired execution result to the result transmission unit 114.

Further, the result acquisition unit 113 acquires, from the verification VM 32, an execution result of the operation transmitted from the command transmission unit 112. Then, the result acquisition unit 113 registers the acquired execution result correspondingly to the operation data 155 as the verification-side output 157. Further, when the acquired execution result is an execution result of the operation transmitted from the terminal device 6, the result acquisition unit 113 outputs the execution result to the result transmission unit 114.

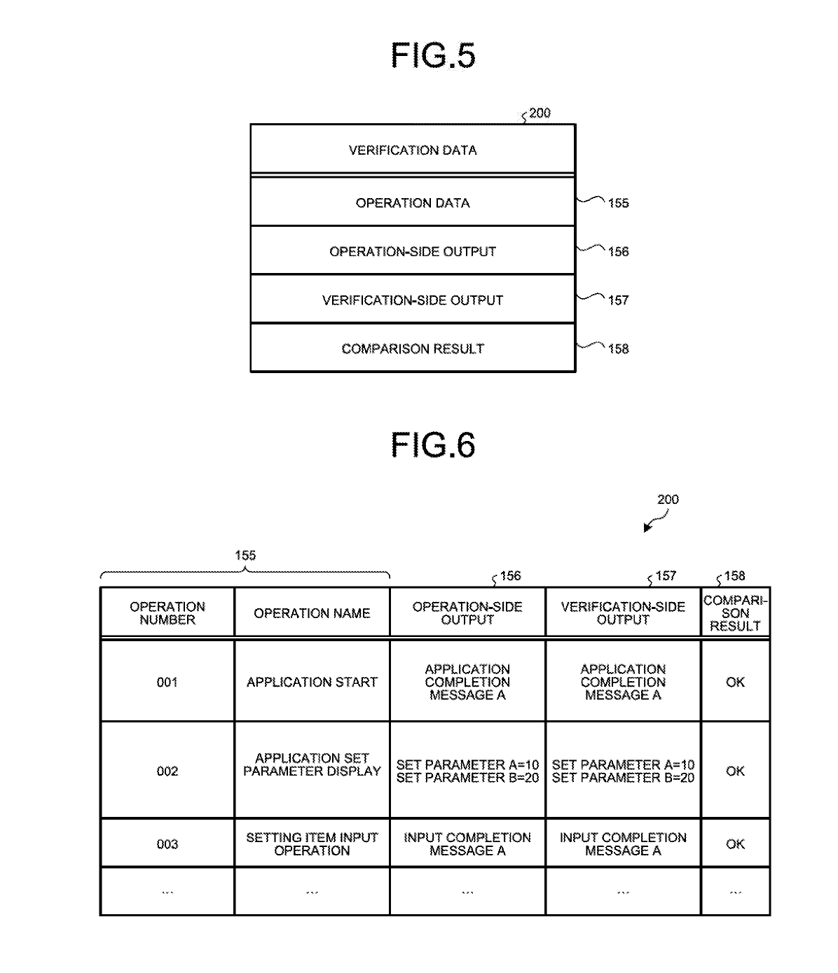

For example, the operation data 155, the operation-side output 156, and the verification-side output 157 are stored in a state as illustrated in FIG. 5. FIG. 5 is a diagram illustrating an example of verification data. Verification data 200 in FIG. 5 is data used when the determination unit 13 described below determines a verification result. The comparison result 158 is data registered by the determination unit 13, and is not registered yet at the point of time when the operation-side output 156 and the verification-side output 157 are registered by the result acquisition unit 113. As illustrated in FIG. 5, the operation data 155, the operation-side output 156, and the verification-side output 157 are registered corresponding to the operation data 155 as the verification data 200. This operation-side output 156 corresponds to an example of a “first execution result” and the verification-side output 157 corresponds to a “second execution result”.

The determination unit 13 receives an input of notification of transmission of an operation to the operational environment VM 31 from the command transmission unit 112. Then, when the transmitted operation is the operation transmitted from the terminal device 6, the determination unit 13 waits until receiving notification of transmission of the same operation to the verification VM 32 from the command transmission unit 112.

After that, when receiving the notification of transmission of the same operation to the verification VM 32 from the command transmission unit 112, the determination unit 13 confirms the input exclusion list 152. Then, when processing by the transmitted operation is an operation registered in the input exclusion list 152, the determination unit 13 deletes the operation-side output 156 and the verification-side output 157 corresponding to the operation data 155 of the transmitted operation. In contrast, when the operation is not the operation registered in the input exclusion list 152, the determination unit 13 compares the operation-side output 156 and the verification-side output 157 corresponding to the operation data 155 of the transmitted operation. Then, the determination unit 13 registers information indicating accordance or discordance between the operation-side output 156 and the verification-side output 157 correspondingly to the operation data 155 as the comparison result 158. For example, the determination unit 13 registers the comparison result 158 correspondingly to the operation data 155 like a state of the verification data 200 of FIG. 5.

Then, the determination unit 13 determines whether a result disaccording with the comparison result 158 is stored, that is, whether a difference exists between the operation-side output 156 and the verification-side output 157. When the comparison result 158 accords, the determination unit 13 determines that the configuration change has succeeded. Then, the determination unit 13 notifies the completion processor 14 of configuration change success. In contrast, when the comparison result 158 disaccords, the determination unit 13 determines that the configuration change has failed. Then, the determination unit 13 notifies the completion processor 14 of configuration change failure.

On the other hand, when the transmitted operation is the operation transmitted from the new function verification terminal device 7, the determination unit 13 acquires the verification-side output 157 corresponding to the operation data 155 of the transmitted operation. Then, the determination unit 13 determines whether the execution result registered in the acquired verification-side output 157 is a desired value determined in advance. When the execution result is the desired value, the determination unit 13 determines that the configuration change has succeeded. Then, the determination unit 13 notifies the completion processor 14 of configuration change success. In contrast, when the execution result is not the desired value, the determination unit 13 determines that the configuration change has failed. Then, the determination unit 13 notifies the completion processor 14 of configuration change failure.

Here, in the present embodiment, the determination unit 13 makes determination of one operation, and notifies the completion processor 14 of success or failure of the configuration change as the determination is made. However, the determination unit 13 may keep the execution results of a plurality of operations and collectively make determination, and may notify the completion processor 14 of a result.

FIG. 6 is a diagram illustrating an example of the verification data corresponding to the operation transmitted from the terminal device. For example, the determination unit 13 creates the verification data 200 illustrated in FIG. 6. In FIG. 6, an operation number and an operation name correspond to the operation data 155. Then, the comparison result 158 between the operation-side output 156 and the verification-side output 157 corresponding to the operation data 155 is registered. In FIG. 6, all the operation-side outputs 156 and the verification-side outputs 157 accord, and values indicating the accordance are registered correspondingly to the respective operation data 155 as the comparison results 158.

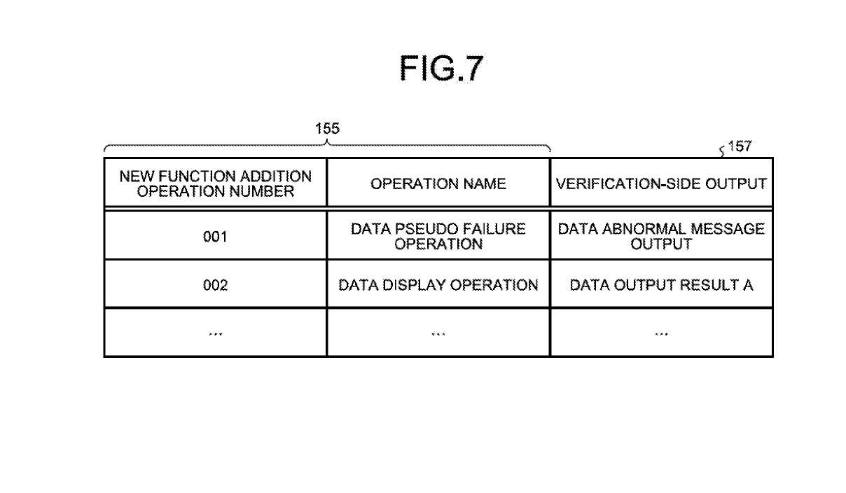

Further, FIG. 7 is a diagram of an example of data to be used for determination of the operation transmitted from the new function verification terminal device. In FIG. 7, a new function addition operation number and an operation name correspond to the operation data 155. The determination unit 13 includes desired values of the execution results corresponding to the respective operation data 155. Then, the determination unit 13 determines that the configuration change has succeeded when the value of the verification-side output 157 corresponding to each operation data 155 accords with the desired value. For example, in the case of FIG. 7, the verification-side output 157 of the operation data 155 named “data pseudo failure operation” is “data abnormal message output”. Therefore, if the desired value for the operation data 155 named “data pseudo failure operation” is “data abnormal message output”, the determination unit 13 determines that the configuration change has succeeded.

The completion processor 14 receives the instruction of verification termination from the input/output control unit 21 of the operation management server 2. Then, the completion processor 14 determines whether having received the notification of configuration change failure from the determination unit 13. If the completion processor 14 has not received the notification of configuration change failure, the completion processor 14 determines that the configuration change has succeeded. Then, the completion processor 14 registers the verification VM 32 as a VM image. The registered VM image may be converted into the operational environment VM 31 and used as verified operational environment VM. Further, configuration change similar to the configuration change added to the verification VM 32 may be added to the operational environment VM 31 and used as the operational environment, and the registered VM image may be used as its backup.

As described above, the information processing system according to the present embodiment duplicates the system of the operational environment to form a verification system, and adds desired configuration change to the verification system to build the verification environment. Then, the information processing system according to the present embodiment causes both the system of the operational environment and the verification system to execute the operation that is used for an actual business performed for the operational environment, thereby to determine success or failure of the configuration change, using the result of the execution.

Accordingly, the configuration change can be verified without creating a test set, and the processing load associated with the verification of the system administrator can be reduced. Further, construction of the verification environment and the configuration change can be automatically performed. Therefore, the load associated with the verification of the system administrator can be further reduced. Especially, in a case where a plurality of systems in a data center, the configuration change and verification for the plurality of systems can be automatically performed, and the load of verification of the system administrator can be substantially reduced.

Further, the operation actually used in the business for the system of the operational environment is employed as a test item, whereby verification for an actual operation can be performed and appropriate verification suitable for the system to be verified can be performed.

### [b] Second Embodiment

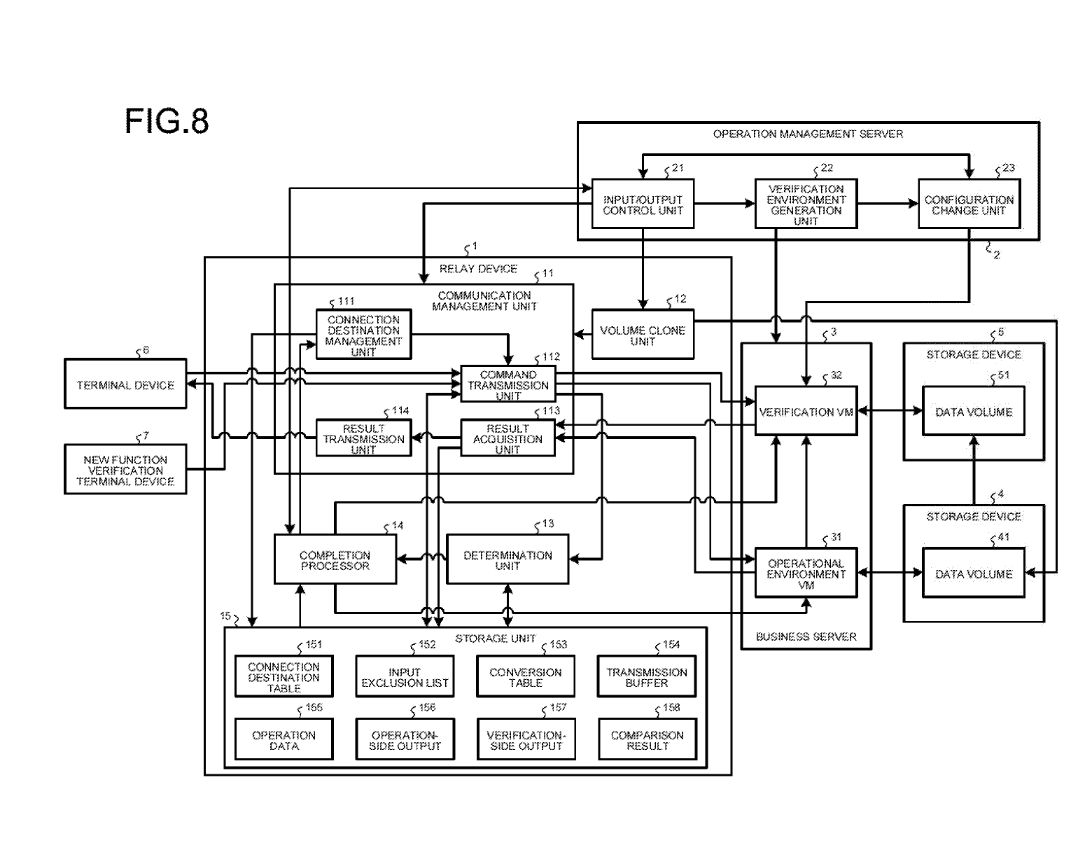

FIG. 8 is a block diagram of an information processing system including a relay device according to a second embodiment. The present embodiment is different from the first embodiment in that a relay device 1 has a mechanism for absorbing a difference in response time between a verification VM 32 and an operational environment VM 31, and filters server-specific information in an execution result and makes a comparison. Units in FIG. 8 having similar reference signs to those in FIG. 1 have similar functions unless otherwise described, and description of the similar functions is omitted in the description below.

A storage unit 15 according to the present embodiment stores a conversion table 153 in addition to the information described in the first embodiment. Further, the storage unit 15 includes a transmission buffer 154.

The transmission buffer 154 is an area in which an operation transmitted to the operational environment VM 31 is temporarily stored in order to transmit the operation according to operation processing by the verification VM 32.

The conversion table 153 is a table for allocating the same value to an item that takes different values between the an operation-side output 156 and a verification-side output 157 even if operations of the operational environment VM 31 and the verification VM 32 are the same.

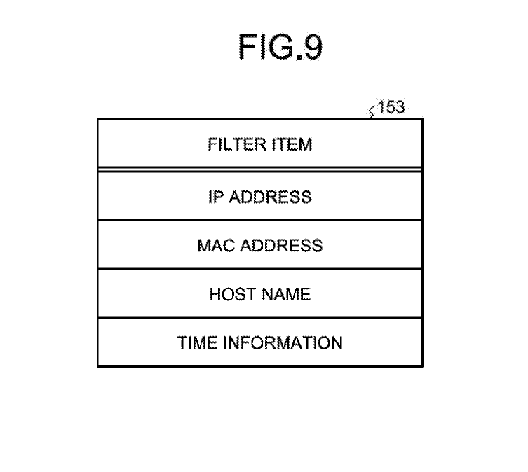

Examples of items registered in the conversion table 153 include an internet protocol (IP) address, a media access control (MAC) address, and server-specific information including a host name, a time, and the like. FIG. 9 is a diagram illustrating an example of the conversion table. For example, the IP address, the MAC address, the host name, and time information are registered in advance to the conversion table 153, as illustrated in FIG. 9. The items described in the conversion table 153 correspond to an example of “change items”. Further, values registered in the conversion table 153 correspond to an example of “predetermined values”.

The conversion table 153 may be stored in the storage unit 15 in advance by a system administrator, using an operation management server 2.

A command transmission unit 112 confirms a connection destination table 151, and identifies a selected verification mode. Then, in a verification mode #1, the command transmission unit 112 performs processing below as transmission of an operation to the operational environment VM 31. The command transmission unit 112 receives an input of an operation from the terminal device 6. Then, the command transmission unit 112 transmits the acquired operation to the operational environment VM 31. Further, the command transmission unit 112 registers the acquired operation as operation data 155. Next, the command transmission unit 112 confirms the transmission buffer 154. In a case where the operation is already stored in the transmission buffer 154, the command transmission unit 112 further stores the operation to the transmission buffer 154, and repeats the processing for the operation transmitted from the terminal device 6.

Further, the command transmission unit 112 performs processing below as transmission of an operation to the verification VM 32. In a case where the operation is stored in the transmission buffer 154, the command transmission unit 112 takes out the oldest operation from the transmission buffer 154. At this time, the command transmission unit 112 deletes the taken out operation from the transmission buffer 154. Then, the command transmission unit 112 transmits the acquired operation to the operational environment VM 31 and the verification VM 32. The command transmission unit 112 repeats the transmission of an operation to the verification VM 32 until no operation stored in the transmission buffer 154. Further, in a case where no operation is stored in the transmission buffer 154 at the point of time when transmitting the operation to the operational environment VM 31, the command transmission unit 112 transmits, to the verification VM 32, the operation transmitted to the operational environment VM 31.

Further, in a verification mode #2, the command transmission unit 112 receives an input of an operation from the terminal device 6 or the new function verification terminal device 7. Then, when receiving the input of an operation from the terminal device 6, the command transmission unit 112 performs processing below as transmission of an operation to the operational environment VM 31. The command transmission unit 112 receives the input of an operation from the terminal device 6. Then, the command transmission unit 112 transmits the acquired operation to the operational environment VM 31. Further, the command transmission unit 112 registers the acquired operation as the operation data 155. Next, the command transmission unit 112 confirms the transmission buffer 154. In a case where the operation is already stored in the transmission buffer 154, the command transmission unit 112 further stores the operation to the transmission buffer 154, and repeats the processing for the operation transmitted from the terminal device 6.

Further, the command transmission unit 112 performs processing below as transmission of an operation to the verification VM 32. In a case where the operation is stored in the transmission buffer 154, the command transmission unit 112 takes out the oldest operation from the transmission buffer 154. At this time, the command transmission unit 112 deletes the taken out operation from the transmission buffer 154. Then, the command transmission unit 112 transmits the acquired operation to the operational environment VM 31 and the verification VM 32. The command transmission unit 112 repeats the transmission of an operation to the verification VM 32 until no operation is stored in the transmission buffer 154. Further, in a case where no operation is stored in the transmission buffer 154 at the point of time when the operation is transmitted to the operational environment VM 31, the command transmission unit 112 transmits, to the verification VM 32, the operation transmitted to the operational environment VM 31.

In contrast, when receiving the input of an operation from the new function verification terminal device 7, the command transmission unit 112 transmits the acquired operation to the verification VM 32. Further, the command transmission unit 112 registers the acquired operation to the operation data 155. In this case, the command transmission unit 112 does not need to adjust timing of the processing of the operation because the command transmission unit 112 does not transmit the operation to the operational environment VM 31, and thus does not need to wait for the operation using the transmission buffer 154.

A determination unit 13 determines whether information corresponding to a filter item registered in the conversion table 153 is stored in the operation-side output 156 and the verification-side output 157 in comparing the execution result of the operation transmitted from the terminal device 6 and performing determination processing. Then, in a case where the information corresponding to a filter item is stored, the information in the operation-side output 156 and the verification-side output 157 is converted into the information registered in the conversion table 153. After that, the determination unit 13 compares the operation-side output 156 and the verification-side output 157, and determines success or failure of configuration change.

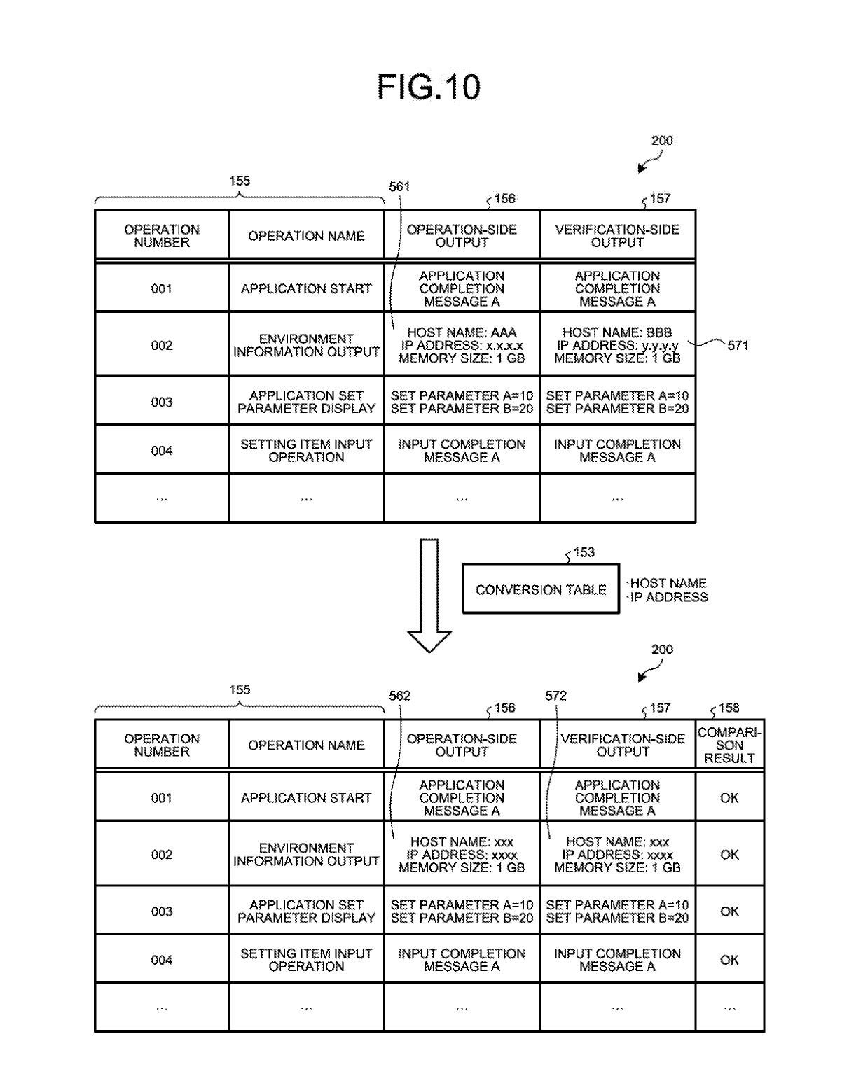

FIG. 10 is a diagram for describing an example of the processing of when comparison is performed using the conversion table. In a stage before conversion using the conversion table 153 is performed, verification data 200 includes items having different values between the operation-side output 156 and the verification-side output 157, as illustrated in data 561 and 571 including information of a host name and an IP address.

Therefore, the determination unit 13 performs conversion of the verification data 200, using the conversion table 153. As illustrated in data 562 and 572, the determination unit 13 performs conversion such that the operation-side output 156 and the verification-side output 157 have the same value. In this case, the determination unit 13 determines that the operation-side output 156 and the verification-side output 157 accord with each other, and determines that the configuration change has succeeded. In this way, the determination unit 13 can make a comparison between the operation-side output 156 and the verification-side output 157, ignoring ignores influence of the server-specific information.

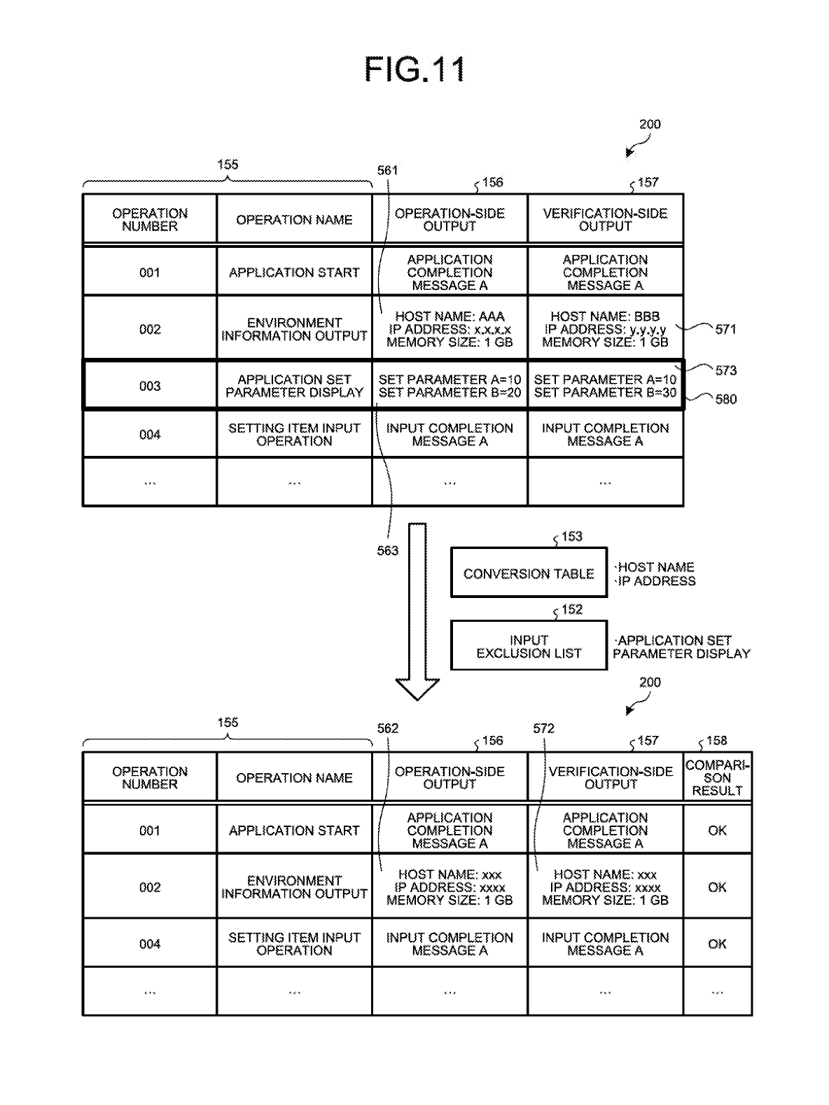

Further, FIG. 11 is a diagram for describing an example of processing of when comparison is performed using an input exclusion list and the conversion table. In a state before conversion using the conversion table 153 is performed, the verification data 200 includes the data 561 and 571 including the information of a host name and an IP address, and having different values. Further, in a case where operation change such as application set parameter display is involved, in a stage before exclusion of an item is performed using an input exclusion list 152, values are different between the operation-side output 156 and the verification-side output 157, as illustrated in data 563 and 573.

Therefore, the determination unit 13 performs conversion of the verification data 200, using the conversion table 153, similarly to the case of FIG. 10. Further, in a case where the processing by the operation corresponding to the operation data 155 is the operation registered in the input exclusion list 152, the determination unit 13 deletes the item corresponding to the operation data 155. That is, the determination unit 13 deletes a row 580 in which the operation data 155 is application set parameter display. Accordingly, the operation data 155 involving operation change is gone from the verification data 200. Then, the determination unit 13 can make a comparison between the operation-side output 156 and the verification-side output 157, ignoring influence of the server-specific information and influence due to the operation change.

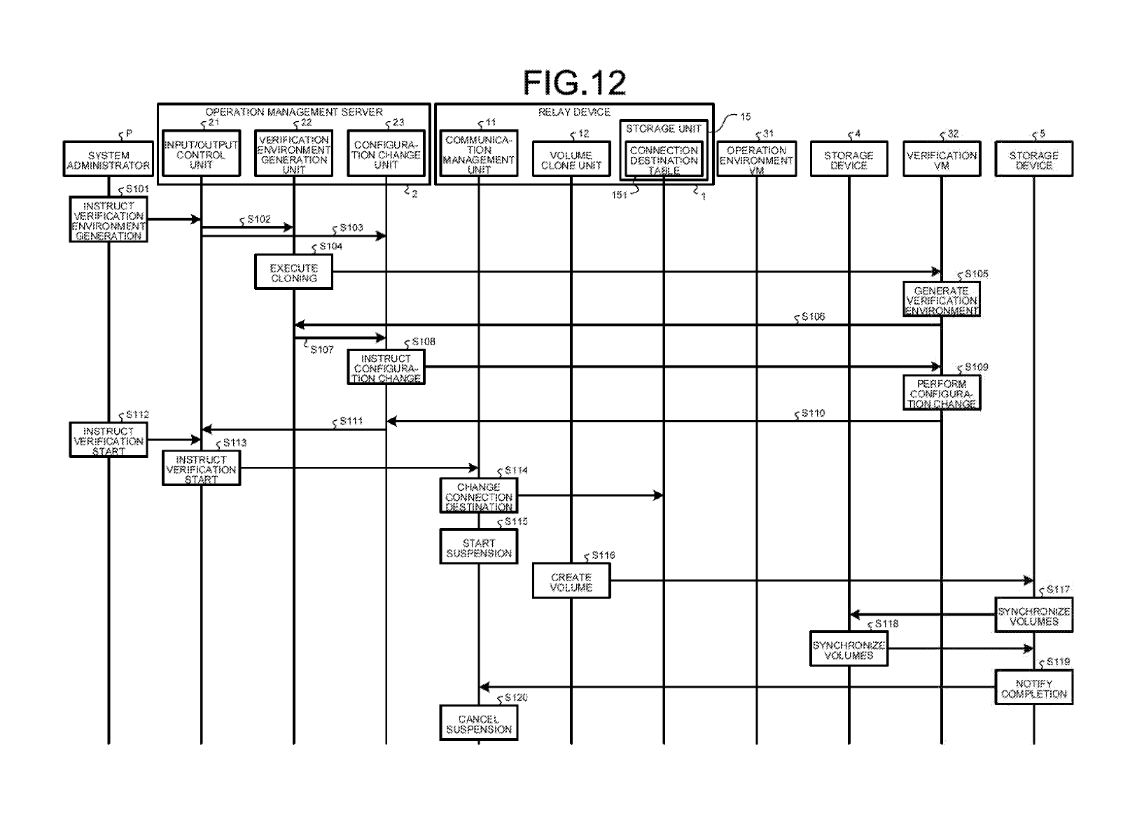

Next, a flow of verification environment generation processing will be described with reference to FIG. 12. FIG. 12 is a sequence diagram of the verification environment generation processing. In FIG. 12, units used in the verification environment generation processing are described and others are omitted.

A system administrator P inputs an instruction of generation of a verification environment to an input/output control unit 21 of the operation management server 2, using an input device (step S101). At this time, the input/output control unit 21 receives an input of content of configuration change together with the instruction of generation of a verification environment.

The input/output control unit 21 outputs the instruction of generation of a verification environment to a verification environment generation unit 22 (step S102). Further, the input/output control unit 21 outputs the content of configuration change to be added to the generated verification VM 32 to a configuration change unit 23 (step S103).

The verification environment generation unit 22 receives the input of the instruction of generation of a verification environment from the input/output control unit 21. Then, the verification environment generation unit 22 instructs execution of cloning to a business server 3 (step S104).

The business server 3 generates the verification VM 32 to generate the verification environment (step S105). After that, the business server 3 transmits notification of generation completion of the verification VM 32 to the verification environment generation unit 22 of the operation management server 2 (step S106). FIG. 12 illustrates that the verification VM 32 performs cloning, for convenience of illustration.

The verification environment generation unit 22 receives the notification of generation completion of the verification VM 32 from the business server 3. Then, the verification environment generation unit 22 outputs the notification of generation completion to the configuration change unit 23 (step S107).

The configuration change unit 23 receives an input of the notification of generation completion from the verification environment generation unit 22. Then, the configuration change unit 23 transmits an instruction of the configuration change to the verification VM 32 (step S108).

The verification VM 32 receives the instruction of the configuration change from the configuration change unit 23. Then, the verification VM 32 executes the instructed configuration change (step S109). After that, the verification VM 32 notifies the configuration change unit 23 of completion of the configuration change (step S110).

The configuration change unit 23 receives the notification of completion of the configuration change from the verification VM 32. Then, the configuration change unit 23 outputs the notification of completion of the configuration change to the input/output control unit 21 (step S111). The input/output control unit 21 notifies the system administrator P of completion of generation of the verification environment.

The system administrator P inputs an instruction of verification start to the input/output control unit 21, using an input device, upon receiving the notification of completion of generation of the verification environment (step S112). The input/output control unit 21 transmits the instruction of verification start to a communication management unit 11 of a relay device 1 (step S113).

The communication management unit 11 receives the instruction of verification start from the input/output control unit 21. Then, the communication management unit 11 selects a verification mode of the connection destination table 151 of the storage unit 15, and instructs connection destination change (step S114). Here, the communication management unit 11 selects the verification mode #1.

Further, the communication management unit 11 starts suspension of communication (step S115).

The volume clone unit 12 instructs a storage device 5 to create a volume similar to a data volume 41 included in a storage device 4 used by the operational environment VM 31 (step S116).

The storage device 5 receives the instruction of creation of the volume from the volume clone unit 12. The storage device 5 notifies the storage device 4 of synchronization between a data volume 51 of the own device and the data volume 41 of the storage device 4 (step S117).

The storage device 4 receives the notification of synchronization of the volumes from the storage device 5. Then, the storage device 4 duplicates content of the data volume 41 to the data volume 51, and synchronizes the volumes (step S118).

The storage device 5 transmits notification of completion of creation of the data volume 51 to the communication management unit 11 (step S119).

The communication management unit 11 receives the notification of completion of creation of the data volume 51 from the storage device 5. Then, the communication management unit 11 cancels the suspension of communication (step S120). Accordingly, an information processing system 10 completes preparation of the verification environment.

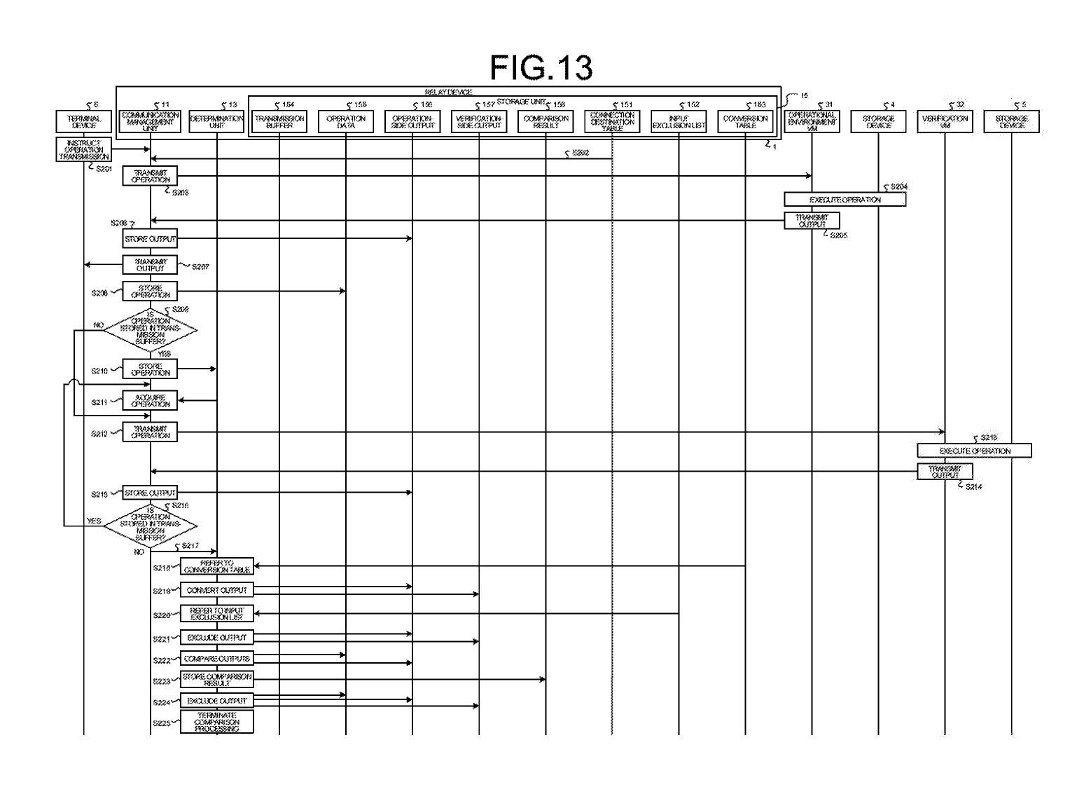

Next, a flow of execution result comparison processing will be described with reference to FIG. 13. FIG. 13 is a sequence diagram of the execution result comparison processing. The processing flow of FIG. 13 is executed after the processing flow of FIG. 12 is completed. Here, a case of executing configuration change not involving an additional function as a type of the configuration change will be described. Further, in FIG. 13, units used in the execution result comparison processing are illustrated and others are omitted.

The terminal device 6 transmits an operation to the communication management unit 11 of the relay device 1 (step S201). The communication management unit 11 acquires information of a connection destination from the connection destination table 151 (step S202).

The communication management unit 11 transmits the operation to the operational environment VM 31 according to the acquired information of a connection destination (step S203).

The operational environment VM 31 receives the operation from the communication management unit 11. Then, the operational environment VM 31 and the storage device 4 execute the received operation (step S204). After that, the operational environment VM 31 transmits an output to the communication management unit 11 (step S205).

The communication management unit 11 receives the output from the operational environment VM 31. Then, the communication management unit 11 stores the received output to the storage unit 15 as the operation-side output 156 (step S206).

Further, the communication management unit 11 transmits the received output to the terminal device 6 (step S207).

Next, the communication management unit 11 stores the operation executed by the operational environment VM 31 to the storage unit 15 as the operation data 155 (step S208).

Next, the communication management unit 11 determines whether the operation is stored in the transmission buffer 154 (step S209). When the operation is stored in the transmission buffer 154 (Yes in step S209), the communication management unit 11 stores the operation executed by the operational environment VM 31 to the transmission buffer 154 in addition to the already stored operation (step S210). In contrast, when the operation is not stored in the transmission buffer 154 (No in step S209), the communication management unit 11 proceeds to step S211. After that, the terminal device 6 and the communication management unit 11 repeat steps S201 to S209 in parallel to step S212 and the subsequent processing.

The communication management unit 11 acquires the operation from the transmission buffer 154 (step S211). At this time, the communication management unit 11 deletes the acquired operation from the transmission buffer 154.

Next, the communication management unit 11 transmits the operation to the verification VM 32 (step S212). To be specific, when the communication management unit 11 determines that the operation is not stored in the transmission buffer 154 in step S209, the communication management unit 11 transmits the operation executed by the operational environment VM 31 to the verification VM 32. Further, when the operation is stored in the transmission buffer 154, the communication management unit 11 transmits the acquired operation to the verification VM 32 at step S211.

The verification VM 32 receives the operation from the communication management unit 11. Then, the verification VM 32 and the storage device 5 execute the received operation (step S213). After that, the verification VM 32 transmits an output to the communication management unit 11 (step S214).

The communication management unit 11 receives the output from the verification VM 32. Then, the communication management unit 11 stores the received output to the storage unit 15 as the verification-side output 157 (step S215).

After that, the communication management unit 11 determines whether an operation remains in the transmission buffer 154 (step S216). When the operation remains in the transmission buffer 154 (Yes in step S216), the communication management unit 11 returns to step S211.

In contrast, when the operation does not remain in the transmission buffer 154 (No in step S216), the communication management unit 11 outputs notification of completion of transmission of the operation to the determination unit 13 (step S217).

The determination unit 13 receives an input of the notification of completion of transmission of the output from the communication management unit 11. The determination unit 13 refers to the conversion table 153 stored in the storage unit 15 (step S218). Then, the determination unit 13 converts values corresponding to filter processing registered in the conversion table 153 in the operation-side output 156 and the verification-side output 157 into the values registered in the conversion table 153 (step S219).

Next, the determination unit 13 refers to the input exclusion list 152 stored in the storage unit 15 (step S220). Next, the determination unit 13 identifies the operation data 155 corresponding to the operation registered in the input exclusion list 152. Then, the determination unit 13 excludes the data corresponding to the identified operation data 155 from the operation-side output 156 and the verification-side output 157 (step S221).

Next, the determination unit 13 compares the operation-side output 156 and the verification-side output 157 (step S222). Then, the determination unit 13 stores a result of the comparison to the storage unit 15 as a comparison result 158 (step S223).

Next, the determination unit 13 deletes the operation data 155, the operation-side output 156, and the verification-side output 157, the comparison of which has been completed, from the storage unit 15 (step S224). Then, the determination unit 13 terminates the comparison processing (step S225).

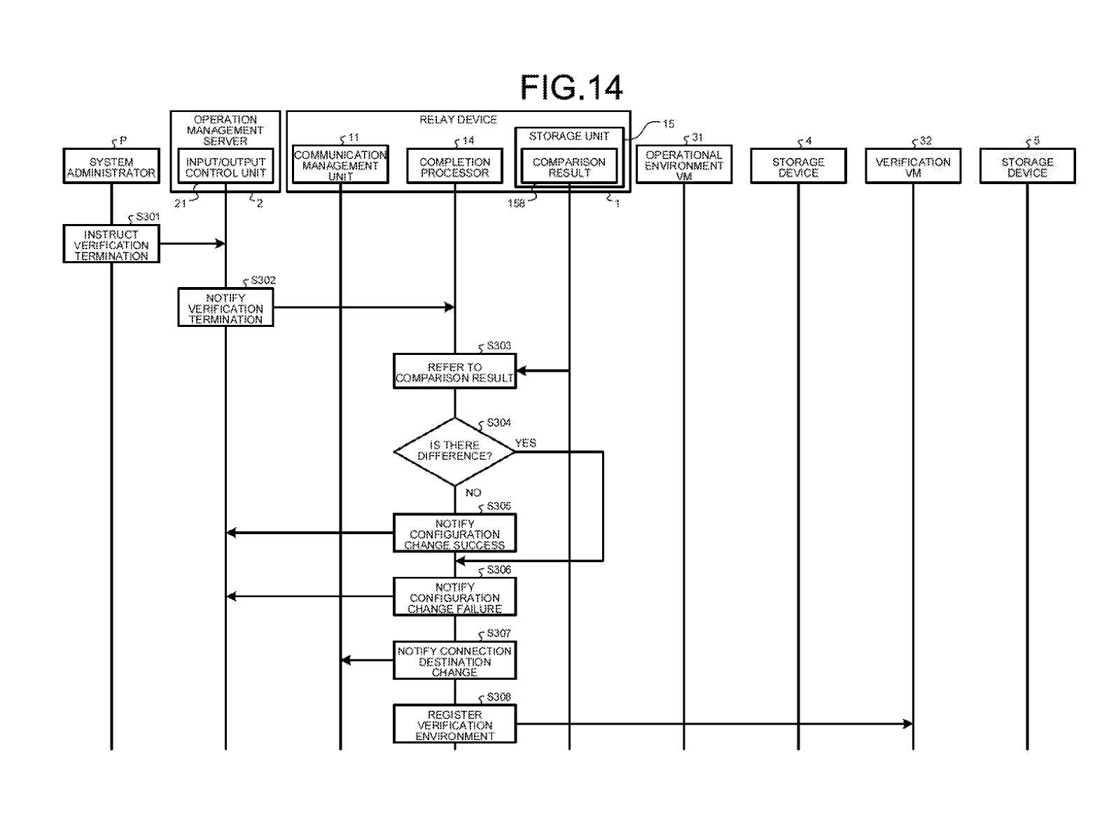

Next, a flow of completion processing will be described with reference to FIG. 14. FIG. 14 is a sequence diagram of the completion processing. In FIG. 14, units used in the completion processing are described and others are omitted.

The system administrator P inputs an instruction of verification termination to the input/output control unit 21 of the operation management server 2, using an input device (step S301).

The input/output control unit 21 transmits the notification of verification termination to a completion processor 14 of the relay device 1 upon receiving an input of the instruction of verification termination (step S302).

The completion processor 14 of the relay device 1 receives the notification of verification termination from the input/output control unit 21. Then, the completion processor 14 refers to the comparison result 158 stored in the storage unit 15 (step S303).

The completion processor 14 determines whether there is a difference between the operation-side output 156 and the verification-side output 157 from the comparison result 158 (step S304). When there is no difference (No in step S304), the completion processor 14 transmits notification of success of the configuration change to the input/output control unit 21 of the operation management server 2 (step S305). In contrast, when there is a difference (Yes in step S304), the completion processor 14 transmits notification of failure of the configuration change to the input/output control unit 21 of the operation management server 2 (step S306).

After that, the completion processor 14 outputs notification of connection destination change to the communication management unit 11 (step S307). The communication management unit 11 selects the verification mode #0 as the connection destination at the normal time from the verification modes in the connection destination table 151 of the storage unit 15, and instructs the connection destination change, upon receiving the notification of connection destination change from the completion processor 14.

After that, the completion processor 14 registers the verification environment, using a virtual image of the verification VM 32 (step S308).

As described above, the relay device according to the present embodiment converts the information having different values in the execution results even if the operations such as the server-specific information are the same, and makes a comparison of the execution results. Accordingly, the execution results can be handled as the same results as long as the operations are the same even if the execution results are different, and the configuration change can be more appropriately verified.

Further, the relay device according to the present embodiment immediately transmits the operation to the operational environment VM, and transmits the operation to the verification VM according to the processing state of the verification VM. Accordingly, even if response times of the operational environment VM and the verification VM are different, the relay device can cause both the operational environment VM and the verification VM to appropriately perform the processing without delaying a response to the user. Therefore, the configuration change can be appropriately verified without exerting influence on the processing of the user.

Hardware Configuration

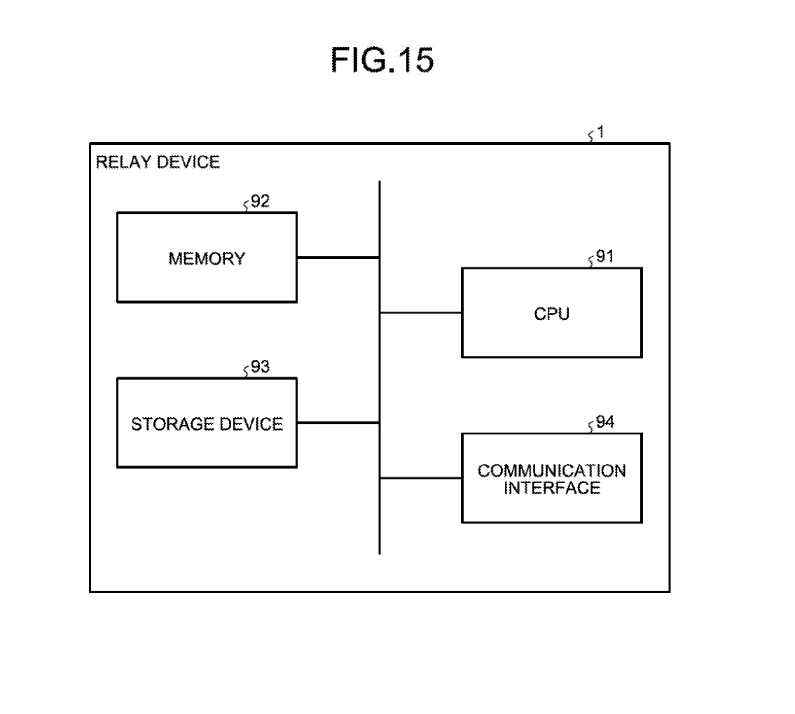

Next, a hardware configuration of the relay device 1 will be described with reference to FIG. 15. FIG. 15 is a hardware configuration diagram of the relay device.

As illustrated in FIG. 15, the relay device 1 includes a central processing unit (CPU) 91, a memory 92, a storage device 93, and a communication interface 94.

The CPU 91 is connected with the memory 92, the storage device 93, and the communication interface 94 by a bus, and performs communication with one another.

The communication interface 94 is an interface for communication between the relay device 1, and the operation management server 2, the business server 3, the terminal device 6, and the new function verification terminal device 7.

The storage device 93 is, for example, a hard disk. The storage device 93 realizes the function of the storage unit 15 exemplarily illustrated in FIGS. 2 and 8. Further, the storage device 93 stores various programs including programs for realizing the functions of the communication management unit 11, the volume clone unit 12, the determination unit 13, and the completion processor 14 exemplarily illustrated in FIGS. 2 and 8.

The CPU 91 reads the various program stored in the storage device 93, expands the programs on the memory 92, and executes the programs to realize the functions of the communication management unit 11, the volume clone unit 12, the determination unit 13, and the completion processor 14 exemplarily illustrated in FIGS. 2 and 8.

Further, the operation management server 2 includes at least a CPU, a memory, and a hard disk. Then, the hard disk of the operation management server 2 stores various programs including programs for realizing the functions of the input/output control unit 21, the verification environment generation unit 22, and the configuration change unit 23 exemplarily illustrated in FIGS. 2 and 8. The CPU of the operation management server 2 reads the various programs stored in the hard disk, expands the programs on the memory of the operation management server 2, and executes the programs. Accordingly, the CPU of the operation management server 2 realizes the functions of the input/output control unit 21, the verification environment generation unit 22, and the configuration change unit 23 exemplarily illustrated in FIGS. 2 and 8.

Note that the programs for realizing the functions of the communication management unit 11, the volume clone unit 12, the determination unit 13, and the completion processor 14 exemplarily illustrated in FIGS. 2 and 8 are allowed to not be stored in the storage device 93 from the start. For example, the programs are stored in a flexible disk to be inserted into the relay device 1, a so-called “portable physical medium”, such as a compact disc (CD), a digital versatile disc (DVD), a magneto-optical disk, or an integrated circuit (IC) card. Then, the relay device 1 may acquire the programs from the portable physical medium and execute the programs. Further, the programs may be stored in another computer or server device connected to the relay device 1 through a public line, the Internet, a local area network (LAN), a wide area network (WAN), and the relay device 1 may acquire and execute the programs from the computer or the server device.

According to one aspect of the information processing apparatus, the information processing system, and the configuration change verification program disclosed by the present application, an effect to reduce the processing load of the system administrator in the verification of the configuration change is exerted.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An information processing apparatus comprising:
a processor configured to:
transmit a command input from a terminal device to a first arithmetic processing device and a second arithmetic processing device generated such that configuration change is added to a configuration of the first arithmetic processing device, and cause the first arithmetic processing device and the second arithmetic processing device to execute the command;
acquire a first execution result by the first arithmetic processing device and a second execution result by the second arithmetic processing device for the transmitted command;
transmit the acquired first execution result to the terminal device; and
determine success or failure of the configuration change on the basis of the first execution result and the second execution result acquired.

2. The information processing apparatus according to claim 1, wherein
the processor is configured to compare the first execution result and the second execution result, and determine that the configuration change has succeeded when the results accord with each other.

3. The information processing apparatus according to claim 2, wherein
the processor is configured to have, in advance, information of an exclusion command that is excluded from comparison, of the command, exclude an execution result of the exclusion command from the first execution result and the second execution result, compare the first execution result and the second execution result after the exclusion, and determine that the configuration change has succeeded when the results accord with each other.

4. The information processing apparatus according to claim 2, wherein
the processor is configured to have, in advance, a change item having different values even if operations of the first execution result and the second execution result are the same, change the values of the change item in the first execution result and in the second execution result to a predetermined value, then compare the first execution result and the second execution result after the change, and determine that the configuration change has succeeded when the results accord with each other.

5. The information processing apparatus according to claim 1, wherein
the processor is configured to wait for transmission of the command to the second arithmetic processing device until the second arithmetic processing device becomes able to process the command input from the terminal device.

6. The information processing apparatus according to claim 1, wherein
the processor is configured to
transmit, when receiving an additional function verification command to be processed by an additional function newly added through the configuration change, the additional function verification command to the second arithmetic processing device,
acquire a third execution result of the additional function verification command executed by the second arithmetic processing device, and
determine success or failure of the additional function on the basis of the acquired third execution result.

7. The information processing apparatus according to claims 1, wherein
the processor is configured to
duplicate an environment of the first arithmetic processing device to generate the second arithmetic processing device; and
add the configuration change to the generated second arithmetic processing device.

8. An information processing system including a first arithmetic processing device, an operation management device, a relay device, and a terminal device,
the operation management device comprising:
a first processor configured to:
duplicate an environment of the first arithmetic processing device to generate a second arithmetic processing device, and
add configuration change to the generated second arithmetic processing device, and
the relay device comprising:
a second processor configured to
transmit a command input from the terminal device to the first arithmetic processing device and the second arithmetic processing device, and cause the first arithmetic processing device and the second arithmetic processing device to execute the command,
acquire a first execution result by the first arithmetic processing device and a second execution result by the second arithmetic processing device for the transmitted command,
transmit the acquired first execution result to the terminal device, and
determine success or failure of the configuration change on the basis of the first execution result and the second execution result acquired.

9. A non-transitory computer-readable recording medium having stored therein a program that causes a computer to execute a process comprising:
transmitting a command input from a terminal device to a first arithmetic processing device and a second arithmetic processing device generated such that configuration change is added to a configuration of the first arithmetic processing device, and causing the first arithmetic processing device and the second arithmetic processing device to execute the command;
acquiring a first execution result by the first arithmetic processing device and a second execution result by the second arithmetic processing device for the transmitted command;
transmitting the acquired first execution result to the terminal device; and
determining success or failure of the configuration change on the basis of the acquired first execution result and the acquired second execution result.
